(19) United States
(12) Patent Application Publication
(10) Pub. No.: US 2016/0353526 A1
(43) Pub. Date: Dec. 1, 2016

(54) HEAT GENERATING GLASS PANEL

(71) Applicant: TGO Tech. Corporation, Hwaseong-si (KR)

(72) Inventors: Yoojin LEE, Yongin-si (KR); Seungeun YI, Osan-si (KR); Jaehak LEE, Seoul (KR)

(21) Appl. No.: 14/722,584

(22) Filed: May 27, 2015

(51) Int. Cl. H05B 3/84

(52) U.S. Cl. CPC H05B 3/84

(57) ABSTRACT

A heat generating glass panel includes a window glass, a plurality of surface films coated and electrically generating heat on a surface of the window glass, and electrically separated from each other by a dividing line, and a plurality of electrodes connected to the surface films to apply heat generating voltages thereto, wherein the surface films include a central surface film and an outer surface film on the surface of the window glass, and wherein the voltages of the electrodes are adjusted in such a manner that a heat generation per unit area of the outer surface film is higher than a heat generation per unit area of the central surface film.

### BACKGROUND

1. Field

The present invention relates to a heat generating glass panel for preventing condensation and, more particularly, to a glass panel capable of efficiently and economically preventing condensation by electrically separating surface films for heating the glass panel into a central surface film and an outer surface film, and heating the central surface film and the outer surface film to different temperatures.

2. Description of the Related Technology

Various windows are installed in openings of walls or doors of a building to block an indoor space from an external environment, and mostly include glass and a frame surrounding the same. Particularly, a window installed in an opening of an outer wall of the building functions to shield the indoor space against external weather changes, and also functions to block external noise or light.

Since glass of the window has relatively low thermal insulation properties compared to a wall, surface temperature of the window glass is generally lower than the indoor space and even lower than the wall. In this case, if an indoor relative humidity level is 50% and the surface temperature of the window glass is lower than the indoor temperature by about 10° C. or more, or if the indoor relative humidity level is 70% and the surface temperature of the window glass is lower than the indoor temperature by about 5° C. or more, condensation occurs on the surface of the glass.

In addition to the condensation, another problem is that the effect of heating the indoor space is reduced due to loss of heat through the glass. If the window has a large size, e.g., a living room window, an additional heater may be necessary for children or elderly people. To prevent the reduction in the heating effect, a heat generating glass panel for supplementing low thermal insulation properties of glass by coating the whole surface of the glass with a heating film having electrical conductivity, flowing a current through the heating film, and thus heating the glass surface has been developed.

This heat generating glass panel is generally designed to a structure in which a nonconductive substrate is coated with a conductive heating material, a first electrode is provided at a side of the conductive heating material, and a second electrode is provided at another side of the conductive heating material. In this case, if a direct-current (DC) or alternating-current (AC) voltage is applied to the first and second electrodes, a current flows through the coated conductive heating material and thus the conductive heating material is heated. However, a conventional window system including the heat generating glass panel places the first and second electrodes at upper and lower parts of a window frame and thus external power sources should be separately connected through upper and lower parts of the window system. As such, electric wire is connected on the floor surface and thus can be touched by a little child. Japanese Patent Publication No. 2000-277243 relates to a plate-shaped electrode having a heating function, and a method for forming the electrode, and discloses a structure in which a conductive heating layer is formed on the surface of a light-transmitting plate material such as a glass plate material and a pair of electrodes are provided by coating a conductive paste to cover metal tape bonded along opposite sides of the plate material. This electrode arrangement has a problem of connecting wires to both upper and lower parts of a sliding window.

In addition, although the conventional electrode arrangement may prevent condensation of the glass window, condensation may still occur at a part near the window frame having much loss of heat due to cold external air, and a large waste of energy may be caused to increase the temperature of the whole glass panel to prevent the condensation of the window frame.

### PRIOR ART DOCUMENT

Japanese Patent Publication No. 2000-277243

### SUMMARY

The present invention provides a heat generating glass panel for efficiently and economically preventing condensation by electrically separating surface films for heating the glass panel from each other, applying different voltages to the separated surface films and achieving different heating values per unit area, and thus increasing temperature more at a part near a window frame having much loss of heat.

According to an aspect of the present invention, there is provided a heat generating glass panel including a window glass, a plurality of surface films coated and electrically generating heat on a surface of the window glass, and electrically separated from each other by a dividing line, and a plurality of electrodes connected to the surface films to apply heat generating voltages thereto, wherein the surface films include a central surface film and an outer surface film on the surface of the window glass, and wherein the voltages of the electrodes are adjusted in such a manner that a heat generation per unit area of the outer surface film is higher than a heat generation per unit area of the central surface film.

The dividing line may include a first dividing line for dividing the electrodes into positive and negative electrodes, and a second dividing line for dividing each of the positive and negative electrodes into predetermined sizes.

A current generated due to the heat generating voltages applied by the electrodes may flow along a predetermined path between the two electrodes divided by the first dividing line, and the path may be split into two by a local insulating region of the surface films corresponding to the first and second dividing lines.

The first dividing line may be a straight line, a first end thereof may contact a first side of a plane formed by the entire surface films, and a second end thereof may extend by a predetermined length in a direction toward a second side facing the first side, may not contact the second side, and may form a closed curve, the second dividing line may be a U-shaped line, and first and second ends thereof may contact the first side contacting the first dividing line at locations spaced apart from the contact location of the first dividing line by a predetermined distance in opposite directions, and the electrodes may be arranged in a length direction of the first side.

The first dividing line may be a straight line, a first end thereof may contact a first side of a plane formed by the entire surface films, and a second end thereof may extend by a predetermined length in a direction toward a second side facing the first side, may not contact the second side, and may form a closed curve, the second dividing line may be a closed line surrounding the closed curve at the second end of the first dividing line, and the electrodes may be arranged in parallel with the first dividing line at a location where the first and second dividing lines cross each other.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic diagram of a heat generating glass panel according to an embodiment of the present invention;

FIG. 2 is a schematic diagram of a heat generating glass panel according to another embodiment of the present invention; and

FIGS. 3A to 3C are circuit diagrams for calculating a heating value based on a resistance.

### DETAILED DESCRIPTION OF THE INVENTION

Reference will now be made in detail to the preferred embodiments of the present invention, examples of which are illustrated in the accompanying drawings.

It should be understood that the terms used in the specification and appended claims should not be construed as limited to general and dictionary meanings. The preferred embodiments described in the specification and shown in the drawings are illustrative only and are not intended to represent all aspects of the invention, such that various equivalents and modifications can be made without departing from the spirit of the invention.

Like reference numerals in the drawings denote like elements, and repeated descriptions thereof will be omitted.

The present invention provides a heat generating glass panel including window glass, a plurality of surface films coated and electrically generating heat on the surface of the window glass, and electrically separated from each other by a dividing line, and a plurality of electrodes 20 connected to the surface films to apply heat generating voltages thereto, wherein the surface films include a central surface film and an outer surface film on the surface of the window glass, and wherein the voltages of the electrodes 20 are adjusted in such a manner that a heat generation per unit area of the outer surface film is higher than a heat generation per unit area of the central surface film. In addition, the heat generating glass panel is fixed into a window frame and usable as a heating glass window, and a part 10 of the heat generating glass panel corresponding to a predetermined width and inserted into the window frame is electrically separated from the other part, insulated, and not heated.

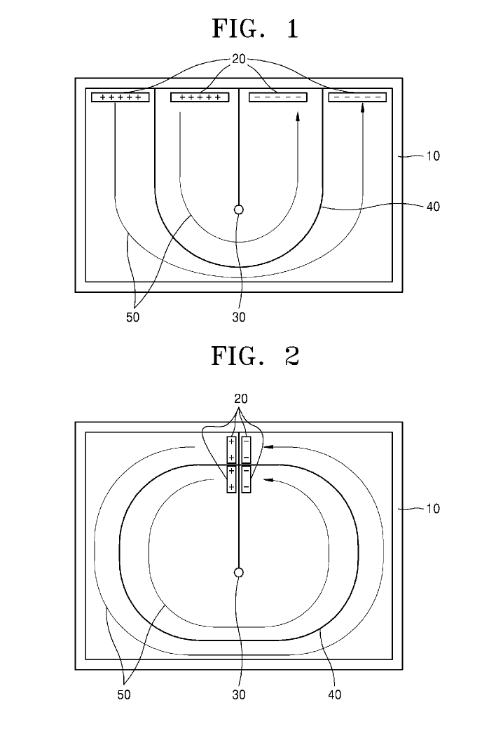

FIG. 1 is a schematic diagram of a heat generating glass panel according to an embodiment of the present invention. In the current embodiment of the present invention, the dividing line includes a first dividing line 30 for dividing the electrodes 20 into positive and negative electrodes, and a second dividing line 40 for dividing each of the positive and negative electrodes into predetermined sizes, and a current may not flow through the dividing line due to a high electrical resistance thereof. A current generated due to the heat generating voltages applied by the electrodes 20 flows along a predetermined path between the two electrodes 20 divided by the first dividing line 30, and the path is split into two by a local insulating region of the surface films corresponding to the first and second dividing lines 30 and 40.

The first dividing line 30 is a straight line, a first end thereof contacts a first side of a plane formed by the entire surface films, and a second end thereof extends by a predetermined length in a direction toward a second side facing the first side, does not contact the second side, and forms a closed curve to prevent glass from being broken due to a large difference in temperature caused by an excessive current density at the end of the first dividing line 30.

The second dividing line 40 is a U-shaped line, and first and second ends thereof contact the first side contacting the first dividing line 30 at locations spaced apart from the contact location of the first dividing line 30 by a predetermined distance in opposite directions. The electrodes 20 are arranged in a length direction of the first side.

FIG. 2 is a schematic diagram of a heat generating glass panel according to another embodiment of the present invention. In the current embodiment of the present invention, the dividing line includes a first dividing line 30 for dividing the electrodes 20 into positive and negative electrodes, and a second dividing line 40 for dividing each of the positive and negative electrodes into predetermined sizes, and a current may not flow through the dividing line due to a high electrical resistance thereof. A current generated due to the heat generating voltages applied by the electrodes 20 flows along a predetermined path between the two electrodes 20 divided by the first dividing line 30, and the path is split into two by a local insulating region of the surface films corresponding to the first and second dividing lines 30 and 40.

The first dividing line 30 is a straight line, a first end thereof contacts a first side of a plane formed by the entire surface films, and a second end thereof extends by a predetermined length in a direction toward a second side facing the first side, does not contact the second side, and forms a closed curve to prevent glass from being broken due to a large difference in temperature caused by an excessive current density at the end of the first dividing line 30. The second dividing line 40 is a closed line surrounding the closed curve at the second end of the first dividing line 30 and, as illustrated in FIG. 2, the electrodes 20 are arranged in parallel with the first dividing line 30 at a location where the first and second dividing lines 30 and 40 cross each other.

The closed curve of the first dividing line 30 may be adjusted in size as necessary, and a current may flow in directions illustrated in FIGS. 1 and 2 or flow in reverse directions by switching the polarities of the electrodes 20. In addition, the first side of the plane formed by the entire surface films, which contacts the first and second dividing lines 30 and 40, may be any of four-direction sides as well as the side illustrated in illustrated in FIGS. 1 and 2. Although not limited to the illustration of FIGS. 1 and 2, most Korean houses has a floor heating system and thus the temperature of a part close to the floor is high irrespective of a main room or a living room. Since outdoor temperature in the cold weather has little difference between a part near the floor and a part near the ceiling, the surface of glass of a window has a large difference in temperature from indoor air at a part relatively close to the floor. That is, since an external side of the window has a constant temperature while an internal side of the window has a relatively high temperature at a part neat the floor, the surface of the window close to the floor exhibits the largest difference in temperature. Accordingly, in the embodiment of FIG. 1, if the electrodes 20 are placed at an upper part of the window and the other three edges having relatively higher temperatures are located toward side and lower parts of the window, condensation mostly occurring at a lower part of the window frame due to a large difference in temperature may be efficiently prevented. As such, the electrodes 20 are preferably placed at an upper part of the window as illustrated in FIG. 1.

In addition, the surface films use transparent conductive oxide (TCO). Since a TCO film simultaneously has a high transmittance of a visible light region and a high electrical conductivity, TCO is used as a transparent electrode material in a variety of display devices. Representative examples of the transparent electrode material include In₂O₃-based, ZnO-based, and SnO₂-based materials, and research has been actively conducted on commercialization thereof for a long time. Among these materials, indium tin oxide (ITO) obtained by doping In₂O₃ with 10 wt % of SnO₂ as an impurity has the best electrical and optical properties and thus is most broadly used as the transparent electrode material in a variety of display devices. However, since indium (In) used as a based material of ITO currently has a price rise and toxicity thereof harmful to the human body has been reported, the present invention uses fluorine doped tin oxide (FTO) having a low price, a high transmittance, and a low resistance. FTO is one of TCO materials and is broadly used in application fields related to solar energy due to excellent optical and electrical properties thereof. An FTO film is highly resistant to bending compared to other oxide conductors. The principle of generating carrier charges by the FTO film is that surplus electrons are generated as fluorine atoms replace oxygen atoms, thereby flowing electricity. FTO-coated glass has a relatively high transmittance (>80%) and a low emissivity (<0.20), and thus is used as hard low-E glass.

The voltages of the electrodes 20 are adjusted in such a manner that a heat generation per unit area of the outer surface film is higher than a heat generation per unit area of the central surface film. As such, edges of the glass panel having much loss of heat due to cold external air, i.e., a part near the window frame, may be maintained at a higher temperature and thus condensation of the window frame may be greatly prevented.

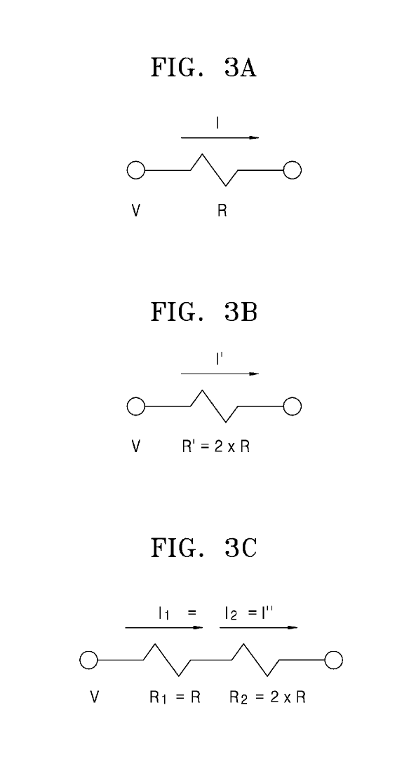

FIGS. 3A to 3C are circuit diagrams for calculating a heating value based on a resistance. FIG. 3A is a circuit diagram for calculating a heating value based on a normal resistance, and the heating value is expressed as given by the following equation.

$$V = I \times R$$

$$\begin{matrix}P = V \times I \\ = {I}^{2} \times R \\ = \frac{{V}^{2}}{R}\end{matrix}$$

FIG. 3B is a circuit diagram for calculating a heating value when the resistance is doubled and a current is constantly maintained, and the heating value is expressed as given by the following equation.

$${I}^{′} = \frac{V}{{R}^{′}} = \frac{1}{2} \times I$$

$$\begin{matrix}{P}^{′} = V \times {I}^{′} \\ = {I}^{′2} \times {R}^{′} \\ = \frac{{V}^{2}}{{R}^{′}} \\ = \frac{{V}^{2}}{2 R} \\ = \frac{1}{2} \times \frac{{V}^{2}}{R} \\ = \frac{1}{2} \times P\end{matrix}$$

The heating value is reduced by half due to the doubled resistance. To solve this problem, if the normal resistance and the doubled resistance are connected in series to each other as illustrated in FIG. 3C, the heating value is calculated as given by the following equation and is doubled.

$${I}^{″} = \frac{V}{{R}^{″}} = {I}_{1} = {I}_{2}$$

$$R = {R}_{1} + {R}_{2}$$

$${V}_{1} = {I}_{1} \times {R}_{2} = {I}^{″} \times R$$

$${V}_{2} = {I}_{2} \times {R}_{2} = {I}^{″} \times 2 R$$

$${P}_{1} = {V}_{1} \times {I}_{1} = {I}^{″2} \times R$$

$$\begin{matrix}{P}_{2} = {V}_{1} \times {I}_{2} \\ = {I}^{″2} \times 2 R \\ = 2 \times {P}_{1}\end{matrix}$$

According to the present invention, a problem of connecting wires to both upper and lower parts of a window may be solved by arranging input and output electrodes at a side of a glass panel, and temperature may be increased more at a part near a window frame having much loss of heat by applying different voltages to and thus achieving different heating values at an outer part and a central part of the glass panel. As such, a heat generating glass panel for efficiently and economically preventing condensation may be provided.

While the present invention has been particularly shown and described with reference to exemplary embodiments thereof, it will be understood by those of ordinary skill in the art that various changes in form and details may be made therein without departing from the spirit and scope of the present invention as defined by the following claims.

Unless otherwise defined, all technical terms used herein have the same meaning as commonly understood by one of ordinary skill in the art. All publications, patent applications, patents, and other references mentioned herein are incorporated by reference in their entirety.

What is claimed is:

1. A heat generating glass panel comprising:
a window glass;
a plurality of surface films coated and electrically generating heat on a surface of the window glass, and electrically separated from each other by a dividing line; and
a plurality of electrodes connected to the surface films to apply heat generating voltages thereto,
wherein the surface films comprise a central surface film and an outer surface film on the surface of the window glass, and
wherein the voltages of the electrodes are adjusted in such a manner that a heat generation per unit area of the outer surface film is higher than a heat generation per unit area of the central surface film.

2. The heat generating glass panel of claim 1, wherein the dividing line comprises:
a first dividing line for dividing the electrodes into positive and negative electrodes; and
a second dividing line for dividing each of the positive and negative electrodes into predetermined sizes.

3. The heat generating glass panel of claim 2, wherein a current generated due to the heat generating voltages applied by the electrodes flows along a predetermined path between the two electrodes divided by the first dividing line, and
wherein the path is split into two by a local insulating region of the surface films corresponding to the first and second dividing lines.

4. The heat generating glass panel of claim 3, wherein the first dividing line is a straight line, a first end thereof contacts a first side of a plane formed by the entire surface films, and a second end thereof extends by a predetermined length in a direction toward a second side facing the first side, does not contact the second side, and forms a closed curve,
wherein the second dividing line is a U-shaped line, and first and second ends thereof contact the first side contacting the first dividing line at locations spaced apart from the contact location of the first dividing line by a predetermined distance in opposite directions, and
wherein the electrodes are arranged in a length direction of the first side.

5. The heat generating glass panel of claim 3, wherein the first dividing line is a straight line, a first end thereof contacts a first side of a plane formed by the entire surface films, and a second end thereof extends by a predetermined length in a direction toward a second side facing the first side, does not contact the second side, and forms a closed curve,
wherein the second dividing line is a closed line surrounding the closed curve at the second end of the first dividing line, and
wherein the electrodes are arranged in parallel with the first dividing line at a location where the first and second dividing lines cross each other.
